(19) United States
(12) Patent Application Publication
(10) Pub. No.: US 2013/0199176 A1
(43) Pub. Date: Aug. 8, 2013

(54) EXHAUST GAS THROTTLE VALVE

(71) Applicants: Luis Carlos Cattani, Aurora, IL (US); Michael D. Bartkowicz, Oswego, IL (US); Martin R. Zielke, Lockport, IL (US); John Zagone, Westmont, IL (US)

(72) Inventors: Luis Carlos Cattani, Aurora, IL (US); Michael D. Bartkowicz, Oswego, IL (US); Martin R. Zielke, Lockport, IL (US); John Zagone, Westmont, IL (US)

(73) Assignee: International Engine Intellectual Property Company LLC, Lisle, IL (US)

(21) Appl. No.: 13/877,832

(22) PCT Filed: Oct. 4, 2010
(86) PCT No.: PCT/US10/51327

§ 371 Date: Apr. 4, 2013

(51) Int. Cl. F02M 25/07

(52) U.S. Cl. CPC F02M 25/0713
USPC 60/602; 123/568.11

(57) ABSTRACT

A method for driving exhaust gas recirculation comprising the steps of restricting exhaust gas flow into the turbine inlet to create backpressure in the exhaust system under low engine operating conditions, and providing an unrestricted exhaust gas flow to the turbine under normal engine operating conditions. Restriction of exhaust gas flow is accomplished through the use of an exhaust gas throttle valve disposed upstream of the turbine inlet. The valves can be adjustable knife edge flap valves or D-shaped valves situated in each passageway of a divided exhaust manifold, which are closed to varying degrees to generate desired levels of backpressure while allowing exhaust gas to pass though open regions of the partially obstructed flow pathway to reach the engine turbocharger. This allows the turbine to continue to spin, while at the same time exhaust gas back pressure upstream of the turbocharger is used to drive exhaust gas recirculation.

### FIELD OF THE INVENTION

This invention relates to internal combustion engines, in particular to exhaust gas recirculation systems for an internal combustion engine.

### BACKGROUND OF THE INVENTION

Multi-cylinder internal combustion engines, particularly diesel engines for large tractor-trailer trucks, may include an exhaust-gas turbocharger. The turbocharger includes a turbine that drives a compressor via a shaft, which generates an increased intake air pressure in the intake duct during normal operation.

Many internal combustion engines use an exhaust gas recirculation (EGR) system to reduce the production of nitrogen oxides (NOx) during the combustion process in the cylinders. EGR systems typically divert a portion of the exhaust gases exiting the cylinders for mixing with intake air. The exhaust gas generally lowers the combustion temperature of the fuel below the temperature where nitrogen combines with oxygen to form nitrogen oxides.

Achieving low levels of NOx emissions in compliance with EPA standards without using NOx after treatment systems requires good EGR driving capabilities at low engine speeds. Typically, good EGR driving capabilities at low engines speeds is accomplished by the use of a variable geometry turbine (VGT) to create the backpressure when needed. The backpressure generated by the VGT becomes the driving means of the EGR at low engine speeds. However, the design complexity and the cost associated with a VGT system is higher than for fixed turbocharger geometry systems. In addition, the lifespan of a VGT used in heavy duty engines can be limited.

Alternatively, other means for driving the EGR have included the use of the intake throttle to drive the EGR. The intake throttle is at least partially closed to reduce the charge air boost pressure that limits the EGR gas flow. While this method eliminates the need for using VGT systems, the air to fuel (NF) ratio deteriorates. For heavy duty applications, this decreased fuel economy is a factor in leading to decreased customer satisfaction.

The present inventors have recognized the need for an efficient method for driving EGR gas flow during low engine speeds without requiring the use of a VGT.

The present inventors have recognized the need for a method of driving EGR gas flow which functions efficiently and satisfactorily under a wide range of engine operating conditions.

The present inventors have recognized the need for a low-cost method of driving EGR gas flow.

### SUMMARY OF THE INVENTION

According to an exemplary embodiment of the present invention, an exhaust gas throttle valve (EGTV) is located in the exhaust system upstream of a turbine of the engine turbocharger. For exhaust systems utilizing a divided exhaust manifold system with a divided turbocharger turbine inlet, an EGTV is present in each gas flow passageway. The EGTV can be knife edge flap valves or D-shaped valves which rotate about a horizontal axis to adjust the amount of exhaust gas supplied to the turbine, and the amount of gas restricted to generate sufficient back pressure to drive the exhaust gas recirculation (EGR). The EGTV is adjusted to provide a restricted flow to the turbine inlet during low engine operating conditions. A portion of the restricted flow provides the backpressure of exhaust gas to drive the EGR. Under normal engine operating conditions, the EGTV is in an open position to provide an unrestricted flow of exhaust gas to the turbine.

By using adjustable backpressure EGTVs upstream of the turbocharger, the system is capable of generating high levels of backpressure. Closing the EGTV increases exhaust manifold pressure to improve EGR drive. Adjusting the valves to a position such that a gap remains between the valves and the exhaust manifold will allow a portion of exhaust gas to flow through, allowing the turbine and the compressor to continue to spin because engine mass flow is not choked off.

Placing the EGTV in the exhaust system upstream of the turbochargers provides a more favorable corrected turbine flow rate, which results in higher expansion ratios, turbine speeds, and compressor boost. The higher compressor boost allows the air system to achieve higher air/fuel (NF) ratios while achieving the desired EGR flow rate. As a result, there is little to no deterioration in the NF ratio, thus eliminating BSFC and soot penalties.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a schematic diagram of an engine system that includes a turbocharger and an exhaust gas recirculation system in accordance with an exemplary embodiment of the invention;

FIG. 2 is a schematic vertical side sectional diagram of a valve assembly useful in an engine exhaust gas recirculation system, taken generally along line 2-2 of FIG. 1.

FIG. 3 is a schematic plan view of the valve assembly of FIG. 2, with a top wall portion removed to view underlying components.

FIG. 3A is a view along line 3A-3A of FIG. 3.

FIG. 4 is a schematic front vertical sectional diagram of an alternate valve assembly useful in an engine exhaust gas recirculation system, taken generally along line 4-4 of FIG. 1.

FIG. 5 is a schematic vertical side sectional diagram of the valve assembly shown in FIG. 4, taken generally along line 2-2 of FIG. 1.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

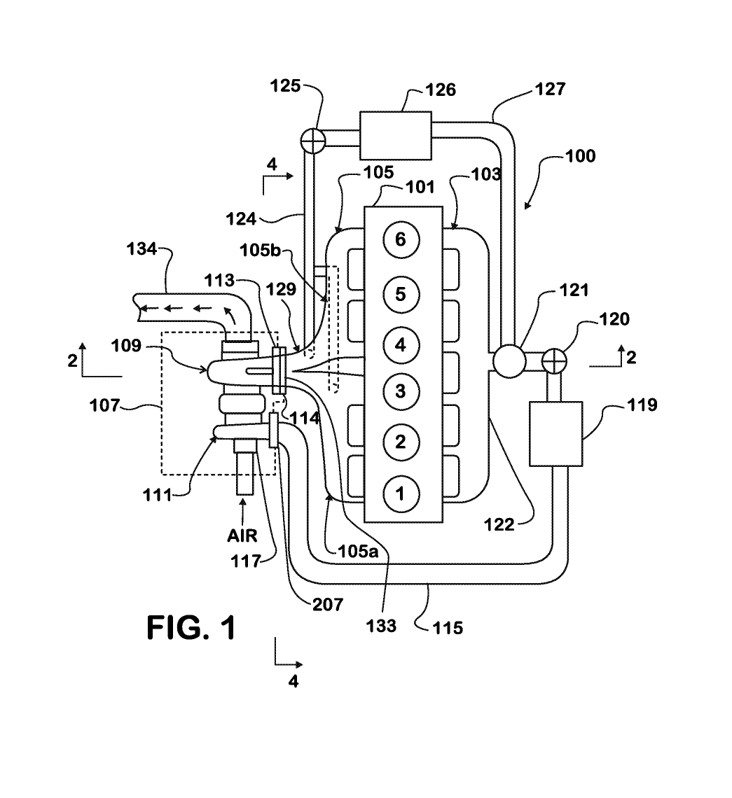

An engine 100 is shown schematically in FIG. 1. The engine 100 has a block 101 that includes a plurality of cylinders. The cylinders in the block 101 are fluidly connected to an intake system 103 and to an exhaust system 105. The exhaust system includes a first pipe 105a from cylinders 1, 2 and 3 of one bank of cylinders and a second pipe 105b from cylinders 4, 5 and 6. Although an inline arrangement of six cylinders is illustrated, inline or V-arrangements or other arrangements of plural cylinders of any number of cylinders are also encompassed by the invention.

A turbocharger 107 includes a turbine 109. The turbine 109 shown has a dual turbine inlet port 113 connected to the exhaust system 105. The turbocharger 107 includes a compressor 111 connected to the intake system 103 through an inlet air passage 115. The turbine can be a divided housing turbine.

During operation of the engine 100, air may enter the compressor 111 through an air inlet 117. Compressed air may exit the compressor 111 through a discharge nozzle 207, pass through the inlet air passage 115, and pass through an optional charge air cooler 119 and an optional inlet throttle 120 before entering an intake air mixer 121 and an intake air manifold 122 of the intake system 103. The compressed air enters the engine cylinders 1-6.

A stream of exhaust gas from the exhaust system 105 may be routed through an exhaust gas recirculation (EGR) passage or conduit 124, through an exhaust gas recirculation (EGR) valve 125, through an EGR cooler 126 and pass through a further EGR conduit 127 before meeting and mixing with air from the inlet throttle 120 at the mixer 121. A more complete description of exhaust gas recirculation systems can be found in U.S. Pat. Nos. 7,140,357; 7,028,680; and 7,032,578, all herein incorporated by reference.

The inlet port 113 of the turbine 109 may be connected to the exhaust pipes 105a, 105b in a manner that forms a divided exhaust manifold 129. Exhaust gas passing through the turbine 109 may exit the engine 100 through a tailpipe 134. Emissions and sound treating components can be arranged to receive the exhaust gas from the tailpipe, before exhausting to atmosphere, as is known.

At times when the EGR valve 125 is at least partially open, exhaust gas flows through pipes 105a, 105b, through the conduit 124, through the EGR valve 125, through the EGR cooler 126, through the further conduit 127 and into the mixer 121 where it mixes with air from the inlet throttle 120. An amount of exhaust gas being re-circulated through the EGR valve 125 may depend on a controlled opening percentage of the EGR valve 125.

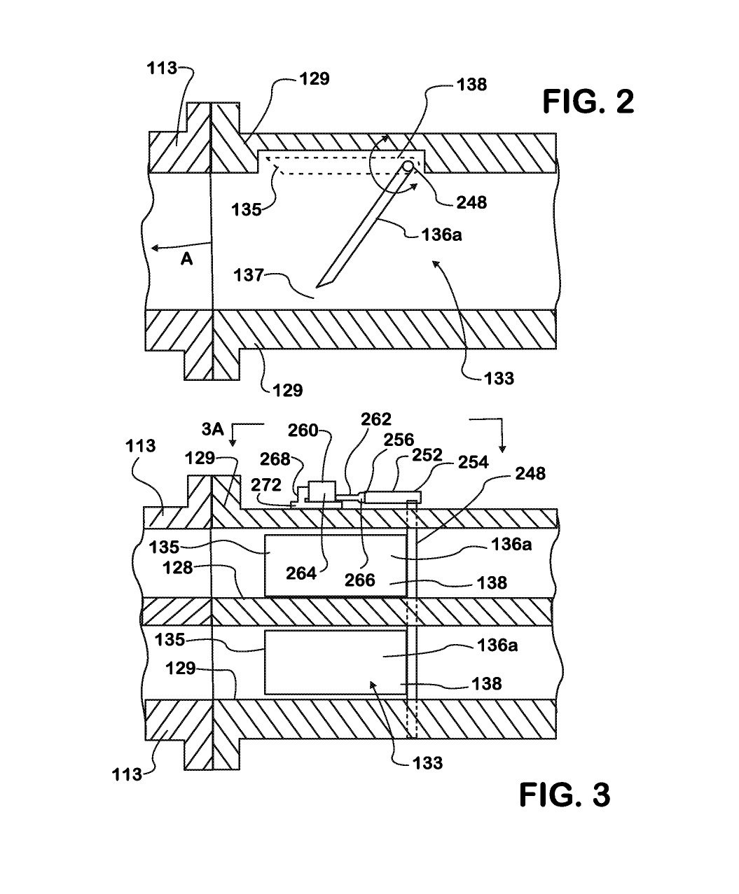

An exhaust gas throttle valve 133 (FIG. 1) is arranged within the exhaust manifold 129. The exhaust gas throttle valve 133 includes valve elements 136a that are adjustable between a closed position, shown in solid, for driving EGR operation, and an open position, shown in dashed (FIG. 2). During normal engine operating speeds where the EGR does not need the additional backpressure, the valve is moved to a horizontal position, as illustrated by dashed lines in FIG. 2, parallel to the direction of exhaust gas flow, to allow exhaust gas to pass through the passage with minimal restriction.

During low engine speeds, the valve elements 136a are adjusted from their open position to a position which restricts at least a portion of the exhaust gas flow, shown in solid lines (FIG. 2). Exhaust gas which passes through the exhaust manifold 129 reaches the turbocharger to maintain turbine speed to maintain a high volume of compressed air from the compressor 111 into the intake system 103.

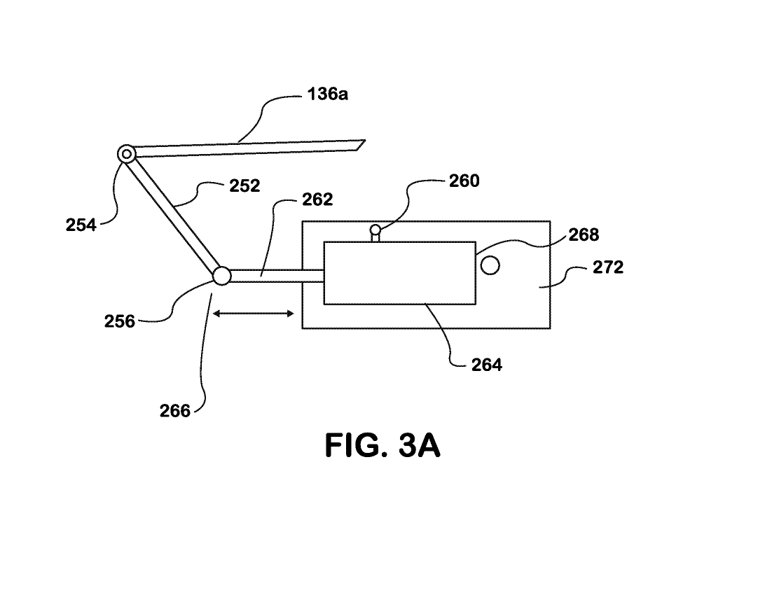

As shown in FIGS. 2 and 3, exhaust gas throttle valve elements can be knife edge flap valve elements 136a which are hinged at the top 138 to a horizontal shaft 248 in a divided manifold system. The valve elements 136a pivot with respect to each channel of the divided manifold allowing gas to enter a divided turbocharger turbine inlet 113. As illustrated in FIG. 2, the knife edge flap valve in its open position is tucked in a recessed portion of the exhaust manifold 129 to minimize the restriction of air flow through the exhaust manifold 129.

The shaft 248 penetrates the manifold 129 through a top thereof and is sealed within the penetration. As illustrated in FIGS. 3 and 3A, a crank 252 is fixed to an end of the shaft 248 at a base end 254 of the crank 252 and is pivotally connected at a distal end 256 to a linear actuator 260. The actuator 260 can be an electric solenoid powered actuator for reciprocal movement of an actuator arm 262 into, and out of, an actuator body 264. The distal end 256 of the crank is pivotally connected to a ball joint or pivotal joint 266 of the arm 262. The actuator 260 is pivotally connected at a base end 268 thereof to a support plate 272 mounted on the manifold 129. The pivotal connection of the actuator 260 allows a small degree of pivoting of the actuator 260 as the arm 262 is moved into, or out of, the body 264. As the arm 262 moves with respect to the body 264, the crank 252 is turned and the valves 136a open or close.

As alternatives to an electrical solenoid powered actuator, a pneumatic cylinder actuator, a hydraulic oil powered actuator, other types of electrical powered actuators, or other known actuators are possible.

As illustrated in FIG. 2, knife edge flap valve elements 136a have a bottom edge 135 which is angled. The angled bottom edge 135 allows for exhaust gas not restricted by the valves in its closed position to flow around the bottom edge 135 towards the turbine inlet in direction A. Without wishing to be bound by any particular theory, it is believed that by blocking flow to the upper half of the turbine housing, and directing flow towards the bottom of the turbine, the expansion of gas as it passes into the turbine housing is minimized and the flow of exhaust gas is directed into the turbine housing with exhaust gas flow directed in a tangential direction to the turbine wheel, at a location that is farthest from the wheel center, to maximize angular velocity of the turbine wheel.

The knife edge flap valve element 136a in FIG. 2 is show in its substantially closed position in solid lines. The closed position can be defined by a stop mechanism situated near shaft 248 to prevent the knife flap valve element 136a from further rotating in a counterclockwise position. Alternatively, the closed position can be defined by the actuator by only allowing the shaft to rotate up to a certain degree of rotation from the open position.

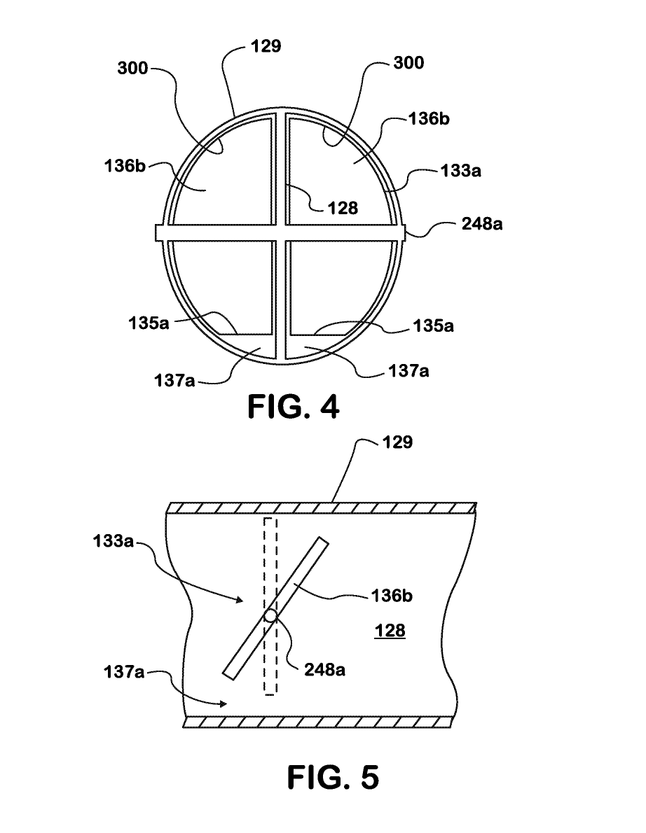

In another embodiment, as illustrated in FIGS. 4 and 5, an exhaust gas throttle valve 133a has D-shaped valve elements 136b to accommodate circular, divided exhaust passages 300, separated by a dividing wall 128. D-shaped valve elements 136b pivot about a shaft 248a passing through the center of each D-shaped valve at its widest region, allowing the D-shaped valve element 136b to rotate between a closed position, shown dashed in FIG. 5, and an open position, shown solid in FIG. 5. The shaft 284a may be rotated by an actuator 260 attached, and operated as described with respect to FIGS. 3 and 3A. The D-shaped valve elements 136b have a bottom edge 135a which has been truncated so as to allow greater exhaust gas flow at the bottom region 137a of the passage compared to the exhaust gas flow that would flow through the bottom region 137 of the valve in its open position without the truncated bottom edge 135a. The truncated bottom edge 135a allows for more exhaust gas flow from the bottom of the passageway towards the turbine when the valve is adjusted to one of its opened positions. In an alternative embodiment, D-shape valves without the truncated bottom edge 135a can also be used.

The valves 133, 133a can be adjusted to any position within a range between a closed position, where maximum restriction of flow occurs, and an open position, where minimum flow restriction occurs, depending on engine operating conditions and desired degree of EGR drive.

In another embodiment, valves 133, 133a could be a separate assembly that can be attached upstream of the turbocharger, and not as part of the exhaust manifold.

The optimal position of the adjustable valves 133, 133a can be calibrated and optimized according to various operating conditions to which the engine is subjected.

In addition to providing a simple, efficient system for exhaust gas recirculation, the valves 133, 133a disclosed can be closed to promote engine warm up during light loads or cold start conditions to increase exhaust back pressure and exhaust gas temperatures. In this mode, the valve functions as a cold aid device. The valves 133, 133a, when closed, also enhance engine braking. The EGVT can be used in combination with a compression release or bleeder brake to create high boost levels, thus resulting in increased engine retarding power. The EGTV can also be used for A/T thermal management by replacing an exhaust valve located downstream of the turbochargers with the EGTV to increase exhaust temperatures, particularly at low engine load conditions, to promote passive regeneration in engine map areas where fuel dosing is needed. Minimizing active regeneration assists in improving fuel economy.

### PARTS LIST

100 engine
101 block
103 intake system
105 exhaust system
105a first exhaust pipe
105b second exhaust pipe
107 turbocharger
109 turbine
111 compressor
115 inlet air passage
119 optional charge air cooler
120 optional inlet throttle
121 inlet air mixer
122 intake manifold
124 EGR conduit
125 EGR valve
126 cooler
127 further conduit
128 dividing wall
129 divided exhaust manifold
132 divided turbine inlet
133, 133a exhaust gas throttle valve
134 tailpipe
135 bottom edge of knife edge flap valves
135a bottom edge of D-shaped valves
136a knife edge flap valve element
136b D-shaped valve element
137 gas flow path at the bottom region of flow passage
137a gas flow path at the bottom region of flow passage
138 top region of knife edge flap valve
201 compressor housing
248 shaft
252 crank
254 base end of crank
256 distal end of crank
260 linear actuator
262 actuator arm
264 actuator body
266 pivotal joint
268 base end of body 264
272 support plate

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A method for driving exhaust gas recirculation in a turbocharged internal combustion engine, the turbocharger having a turbine and a compressor, the turbine having a turbine wheel within a turbine housing, the turbine housing having a first inlet, a second inlet and an outlet, the turbine wheel operatively connected to the compressor to spin a compressor wheel within the compressor to pressurize intake air into an intake manifold of the engine, comprising the steps of:
providing an unrestricted flow of exhaust gas into the first inlet and the second inlet during first engine operating conditions;
providing a restricted flow of exhaust gas into the first inlet and the second inlet during second engine operating conditions;
providing an increased exhaust back pressure upstream of the first inlet and the second inlet during second engine operating conditions; and
routing exhaust gas from upstream of the first inlet and the second inlet to the intake manifold.

2. The method of claim 1, wherein a portion of the restricted flow of exhaust gas provides the exhaust back pressure.

3. The method of claim 1, wherein the amount of restriction of exhaust gas varies depending on engine operating conditions.

4. The method of claim 3, wherein the amount of restriction within each of the first and second inlets is to the same degree.

5. The method of claim 1, wherein the restricted flow entering the first and second turbine inlets enters at the bottom of the first and second turbine inlets.

6. The method of claim 1, wherein the restricted flow into the first and second turbine inlets provides a predetermined exhaust flow rate to drive the turbine wheel.

7. The method of claim 1, wherein the exhaust backpressure provides a predetermined back pressure to drive the exhaust gas recirculation.

8. The method of claim 1, wherein the step of providing restricted air flow is accomplished by rotating or pivoting an exhaust gas throttle valve within the first inlet and second inlet into a position between an open and a closed position.

9. The method of claim 1, wherein the step of providing an unrestricted flow during normal engine operating conditions is accomplished by maintaining an unobstructed cross section through the first and second inlets.

10. An exhaust gas recirculation system, comprising:
a turbocharger having a turbine and a compressor, the turbine having a turbine wheel within a turbine housing, the turbine housing with a first inlet, a second inlet and an outlet, the turbine wheel operatively connected to the compressor to spin a compressor wheel within the compressor to pressurize intake air into the engine;
a set of exhaust gas throttle valve elements having an open and a substantially closed position;
an exhaust manifold receiving exhaust gas from the engine and having a first outlet flow path and a second outlet flow path, each outlet flow path connected to one of the first or second inlets of the turbine through the exhaust gas throttle valve elements located within the respective first and second flow paths, wherein said closed position provides a reduced flow past the valve for providing a predetermined exhaust flow rate to drive the turbine wheel; and
an exhaust gas recirculation path taking exhaust gas from upstream of the exhaust gas throttle valve elements and routing the exhaust gas to mix with pressurized intake air into the engine.

11. The exhaust gas recirculation system according to claim 10, wherein the turbine comprises a divided turbine housing.

12. The exhaust gas recirculation system according to claim 10, wherein the exhaust gas throttle valves comprise knife edge flap valve elements pivotally connected at one end with respect to the exhaust manifold to be rotatable between two positions corresponding to the open and closed positions.

13. The exhaust gas recirculation system according to claim 12, wherein the knife edge flap valve elements are tucked in a recessed portion of the exhaust manifold.

14. The exhaust gas recirculation system according to claim 10, wherein the exhaust gas throttle valves comprise D-shaped valve elements pivotally connected at their widest region to be rotatable between two positions corresponding to the open and closed positions.

15. The exhaust gas throttle valves of claim 14 wherein the D-shaped valve elements comprise a truncated bottom edge.

16. The exhaust gas recirculation system according to claim 10, wherein the exhaust gas throttle valve elements are mounted on a common shaft, driven by a common operation.
